(19) United States
(12) Patent Application Publication
(10) Pub. No.: US 2012/0301367 A1
(43) Pub. Date: Nov. 29, 2012

(54) REACTION VESSEL

(75) Inventor: Hiroshi KOEDA, Suwa (JP)

(73) Assignee: Seiko Epson Corporation, Tokyo (JP)

(21) Appl. No.: 13/475,011

(22) Filed: May 18, 2012

(30) Foreign Application Priority Data
May 23, 2011 (JP) 2011-114414

(51) Int. Cl. B01J 14/00

(52) U.S. Cl. 422/236

(57) ABSTRACT

A reaction vessel which satisfies a relationship A<C+D<A+B on the assumption that the capacities of a first chamber and a second chamber are A and B, respectively, and that the volumes of a liquid stored in the first chamber and a liquid stored in the second chamber are C and D, respectively, so as to prevent entrance of bubbles into the reaction vessel.

### CROSS-REFERENCE

This application claims priority to Japanese Patent Application No. 2011-114414, filed May 23, 2011, the entirety of which is hereby incorporated by reference.

### BACKGROUND

1. Technical Field

The present invention relates to a reaction vessel.

2. Related Art

Recently, with discovery of various genes relating to diseases and ailments, medical treatments utilizing genes such as genetic examinations and genetic therapies have been attracting attention. Moreover, a number of methods utilizing genes have been developed in the agricultural and stock-raising field for species distinction and species improvement, as expansion of technologies utilizing genes. For the purpose of utilizing genes, nucleic acid amplification techniques have been widely employed in these days. Typical known examples of the nucleic acid amplification techniques at present include a PCR (polymerase chain reaction) method. Today, the PCR method has become an essential and indispensable method for clarification of biological substance information.

For example, JP-A-2009-136250 proposes a biological sample reaction chip and a biological sample reactor as a device for performing the PCR method. This device shifts a small amount of a reaction liquid by gravity within a vessel filled with oil not miscible with the reaction liquid so as to efficiently apply a thermal cycling to the reaction liquid.

According to the technology disclosed in JP-A-2009-136250, a required condition during use is that the biological sample reaction chip is filled with the oil and the reaction liquid. However, when the reaction liquid is introduced into the reaction chip, bubbles enter the reaction chip in some cases together with the reaction liquid.

In the case where a thermal cycling is applied to the reaction liquid using a thermal cycling device which shifts the reaction liquid by gravity in the reaction vessel, bubbles existing in the reaction vessel move by gravity together with the reaction liquid inside the reaction vessel. In this condition, these bubbles in some cases prevent adequate movement of a liquid drop of the reaction liquid, or produce unnecessary flow of oil within the reaction vessel in accordance with the shift of the bubbles, which may cause disorder of temperature control within the reaction vessel.

### SUMMARY

An advantage of some aspects of the invention is to provide a reaction vessel into which bubbles are difficult to enter.

(1) An aspect of the invention is directed to a reaction vessel including: a vessel chamber including an opening, a first area, and a second area which is closer to the opening than the first area; a cover capable of sealing at least a part of the first area to define a first chamber and sealing at least a part of the second area to define a second chamber; and a first liquid stored in the vessel chamber. When a second liquid not miscible with the first liquid is introduced through the opening into the vessel chamber, on the assumption that the capacities of the first chamber and the second chamber are A and B, respectively, and the volumes of the first liquid and the second liquid are C and D, respectively, a relationship A<C+D<A+B holds.

The first area is disposed relatively far from the opening of the vessel chamber, while the second area is disposed relatively close to the opening of the vessel chamber. Therefore, the first chamber is positioned relatively far from the opening of the vessel chamber, while the second chamber is positioned relatively close to the opening of the vessel chamber.

According to this aspect of the invention, the relationship A<C+D holds. In this case, the first chamber sealed by the cover can be brought into the condition filled with the first liquid and the second liquid. Under this condition, bubbles do not easily enter the first chamber of the reaction vessel.

Moreover, since the relationship C+D<A+B holds in this aspect of the invention, the first liquid and the second liquid do not overflow from the second chamber sealed by the cover. When the first liquid and the second liquid overflow from the second chamber, the overflow of the first and second liquids needs to be wiped off or removed by other methods, for example, before attachment of the reaction vessel to a thermal cycling device, which complicates the work necessary for causing reaction. According to this aspect of the invention, however, there is no possibility of overflow of the first liquid and the second liquid from the second chamber. Thus, the work necessary for the reaction becomes simpler.

(2) The shape of the first chamber of the reaction vessel may be a shape having a longitudinal direction.

According to this structure, the shift route of the second liquid within the first chamber can be regulated to some extent. Thus, a thermal cycling can be easily applied to the second liquid using a thermal cycling device which shifts the second liquid by gravity within the reaction vessel, for example.

(3) The second chamber of the reaction vessel may be disposed near one end of the first chamber in the longitudinal direction of the first chamber.

According to this structure, bubbles having entered the first area disposed relatively far from the opening can easily shift toward the second area disposed relatively close to the opening when the opening of the vessel chamber is open to above in the direction of gravity. Bubbles which do not easily enter the first area are difficult to come into the first chamber. Therefore, entrance of bubbles into the first chamber of the reaction vessel can be further prevented.

### BRIEF DESCRIPTION OF THE DRAWINGS

The invention will be described with reference to the accompanying drawings, wherein like numbers reference like elements.

FIGS. 1A and 1B schematically illustrate a cross-sectional structure of a reaction vessel 1 according to a first embodiment.

FIG. 2 schematically illustrates a condition of the reaction vessel 1 into which a second liquid 40 is introduced.

FIGS. 3A and 3B schematically illustrate a cross-sectional structure of a reaction vessel 2 according to a second embodiment.

FIG. 4 schematically illustrates a condition of the reaction vessel 2 into which the second liquid 40 is introduced.

FIG. 5A is a perspective view illustrating a condition of a thermal cycling device 1000 whose cover 1050 is closed.

FIG. 5B is a perspective view illustrating a condition of the thermal cycling device 1000 whose cover 1050 is opened.

FIG. 6 is a perspective view illustrating a main body 1010 of the thermal cycling device 1000 in a disassembled condition.

FIG. 7A is a cross-sectional view schematically illustrating a cross section of the thermal cycling device 1000 in a first position taken along a plane passing through a line A-A in FIG. 5A and perpendicular to a rotation axis R.

FIG. 7B is a cross-sectional view schematically illustrating a cross section of the thermal cycling device 1000 in a second position taken along the plane passing through the line A-A in FIG. 5A and perpendicular to the rotation axis R.

### DESCRIPTION OF EXEMPLARY EMBODIMENTS

Preferred embodiments according to the invention are hereinafter described in detail with reference to the drawings. The respective embodiments discussed herein, however, do not unreasonably limit the scope of the invention as claimed in the appended claims. Also, all the structures shown in the following description are not necessarily required as essential elements for practicing the invention.

### 1. Reaction Vessel of First Embodiment

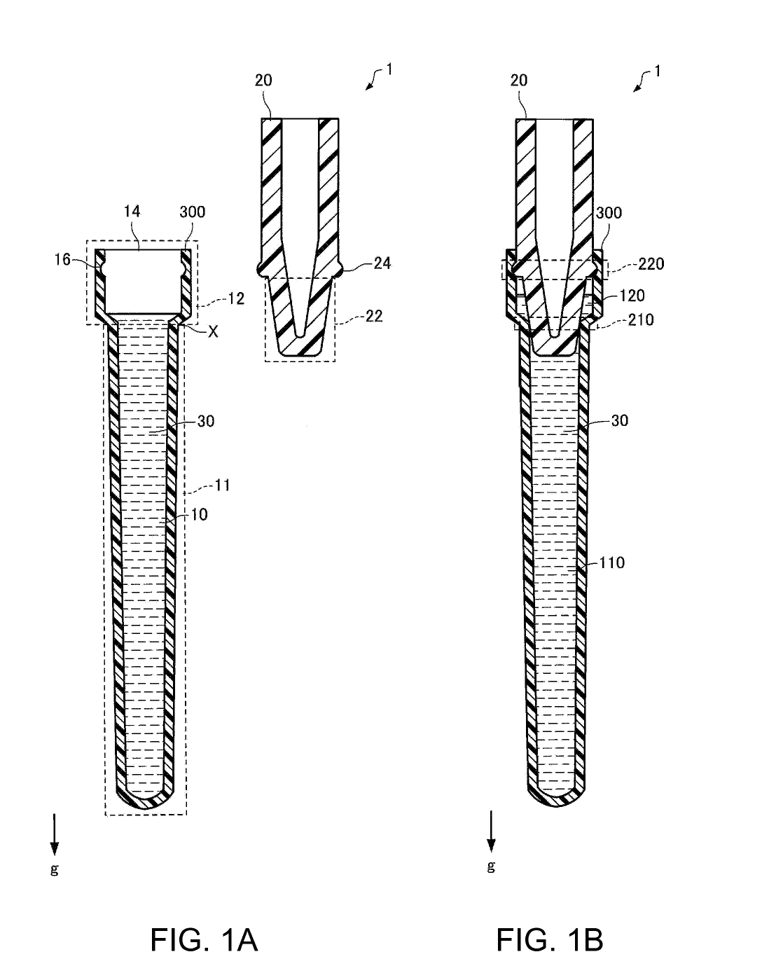

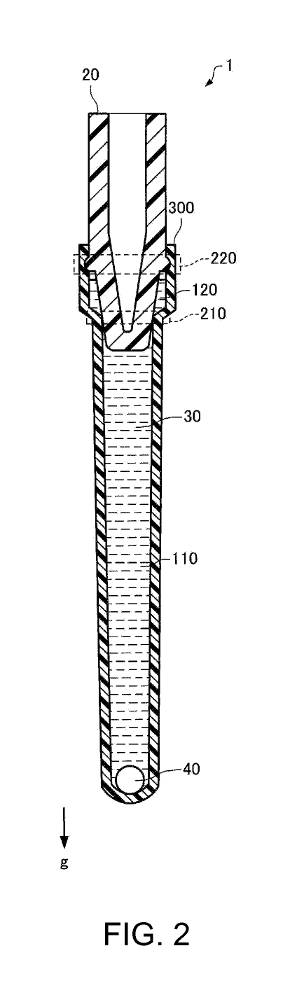

FIGS. 1A and 1B schematically illustrate a cross-sectional structure of a reaction vessel 1 according to a first embodiment. FIG. 1A shows a condition of the reaction vessel 1 whose cover 20 is removed from a vessel main body 300, while FIG. 1B shows a condition of the reaction vessel 1 whose cover 20 is attached to the vessel main body 300. FIG. 2 schematically illustrates a condition of the reaction vessel 1 into which a second liquid 40 is introduced. In each of FIGS. 1A, 1B, and 2, an arrow g indicates the direction of gravity.

The reaction vessel 1 according to the first embodiment includes a vessel chamber 10 having an opening 14, a first area 11, and a second area 12 to which the opening 14 is positioned closer than to the first area 11, a cover 20 which seals at least a part of the first area 11 to define a first chamber 110 and also seals at least a part of the second area 12 to define a second chamber 120, and a first liquid 30 stored in the vessel chamber 10. The reaction vessel 1 is so constructed as to satisfy the relationship A<C+D<A+B on the assumption that the capacities of the first chamber 110 and the second chamber 120 are A and B, respectively, and that the volumes of the first liquid 30 and the second liquid 40 are C and D, respectively, when the second liquid 40 not miscible with the first liquid 30 is introduced through the opening 14 into the vessel chamber 10.

According to the example shown in FIGS. 1A and 1B, the reaction vessel 1 includes the vessel main body 300 and the cover 20. The external shape of the vessel main body 300 may be arbitrarily determined. While the size and shape of the vessel main body 300 are not specifically limited, they may be determined in accordance with the application of the reaction vessel 1, that is, considering at least one of the following factors: the amount of the stored first liquid 30, heat conductivity; the shapes of the first chamber 110 and the second chamber 120; and the handling easiness, for example. The materials of the vessel main body 300 and the cover 20 are not specifically limited. For example, the vessel main body 300 and the cover 20 may be made of inorganic material (such as heat-resisting glass (Pyrex (registered trademark)), organic material (such as polycarbonate, polypropylene and other resin), or a composite of these materials. When the reaction vessel 1 is used as a reaction vessel (reaction chip) for the PCR method or for other purposes including fluorometry, it is preferable that the vessel main body 300 is made of less auto-fluorescence material. Examples of less auto-fluorescence material include polycarbonate and polypropylene. In addition, when the reaction vessel 1 is used as a reaction vessel for the PCR method, it is preferable that the reaction vessel 1 is made of material which can endure heating during the PCR process.

Black substances such as carbon black, graphite, black titanium oxides, aniline black, oxides of Ru, Mn, Ni, Cr, Fe, Co, or Cu, and carbides of Si, Ti, Ta, Zr, or Cr, for example, may be added to the materials of the vessel main body 300 and the cover 20. The vessel main body 300 and the cover 20 mixed with these black substances can further reduce auto-fluorescence of resin or the like. When the reaction vessel 1 is used for purposes including observation of the interior of the first chamber 110 from the outside of the reaction vessel 1 (such as real time PCR), the materials of the vessel main body 300 and the cover 20 may be transparent if necessary. The degree of “transparency” required herein is only a level sufficient for the purpose of use of the reaction vessel 1. For example, in case of visual observation, the reaction vessel 1 only needs to have a degree of transparency sufficient for allowing visual recognition of the interior.

For the purpose of fluorometry in the real time PCR method or the like, the requirement is only a level sufficient for allowing optical measurement of fluorescence of the reaction liquid from the outside of the reaction vessel 1. When the reaction vessel 1 is used as a reaction chip of the PCR method, it is preferable that the vessel main body 300 and the cover 20 are made of materials absorbing less nucleic acids and proteins and not inhibiting reaction of enzymes such as polymerase.

The vessel main body 300 includes the vessel chamber 10 as a hollow formed inside the vessel main body 300. The vessel chamber 10 has the opening 14, the first area 11, and the second area 12. The vessel chamber 10 communicates with the space outside the vessel main body 300 via the opening 14. The shape of the vessel chamber 10 may be arbitrarily determined as long as it meets other requirements specified in this section. According to the reaction vessel 1 in the first embodiment, the shape of the vessel chamber 10 is determined in such a form that the cross-sectional shape is circular in the horizontal direction in FIGS. 1A and 1B, and that the inside diameter of the circular shape differs for each position on the vessel chamber 10 in the vertical direction (height direction) in FIGS. 1A and 1B.

The first area 11 is disposed within the vessel chamber 10 at a position relatively far from the opening 14. The second area 12 is disposed within the vessel chamber 10 at a position relatively close to the opening 14. Thus, the opening 14 is positioned farther from the first area 11 than from the second area 12, and positioned closer to the second area 12 than to the first area 11. According to the example shown in FIGS. 1A and 1B, the region located relatively far from the opening 14 corresponds to the first area 11, and the region located relatively close to the opening 14 corresponds to the second area 12, with the boundary between these areas 11 and 12 positioned at a step X where the inside diameter rapidly increases (change of the inside diameter becomes larger) from the side away from the opening 14 toward the opening 14. Thus, according to the example shown in FIGS. 1A and 1B, the inside diameter of the second area 12 is larger than the inside diameter of the first area 11. The ratio of the capacity of the first area 11 to that of the second area 12 may be arbitrarily determined as long as it meets other requirements specified in this section.

The vessel chamber 10 stores the first liquid 30. The first liquid 30 is a liquid not miscible with the second liquid 40 (the details of which will be described later). The first liquid 30 may be constituted by dimethyl silicon oil or paraffin oil, for example.

The cover 20 is so constructed as to be attachable to the vessel main body 300. The cover 20 is attached to the vessel main body 300 by insertion of apart of the cover 20 into the opening 14 communicating with the vessel chamber 10 of the vessel main body 300. According to the example shown in FIGS. 1A and 1B, the cover 20 is provided as a cap fitted into the vessel chamber 10 of the vessel main body 300. The cover 20 is not limited to a cover of this type but may have a screw cap structure attached to the vessel main body 300 by screw-engagement therewith, for example. The cover 20 is also so constructed as to be detachable from the vessel main body 300.

The cover 20 is so designed as to seal at least a part of the first area 11 of the vessel chamber 10 (that is, a part or the whole of the first area 11) to define the first chamber 110. Similarly, the cover 20 is so designed as to seal at least a part of the second area 12 of the vessel chamber 10 (that is, a part or the whole of the second area 12) to define the second chamber 120. Therefore, the cover 20 is provided as a part of a sealing mechanism capable of switching the condition of the vessel chamber 10 between a sealing condition in which at least a part of the first area 11 of the vessel chamber 10 and at least a part of the second area 12 of the vessel chamber 10 are sealed to define the first chamber 110 and the second chamber 120, and a non-sealing condition in which the vessel chamber 10 is not sealed (the vessel chamber 10 communicates with the space outside the vessel main body 300).

The sealing mechanism includes a first sealing portion 210 which seals at least a part of the first area 11 of the vessel chamber 10 to define the first chamber 110, and a second sealing portion 220 which seals at least a part of the second area 12 of the vessel chamber 10 to define the second chamber 120. It is preferable that the first sealing portion 210 has a highly airtight structure so as to prevent entrance of bubbles into the first chamber 110. It is also preferable that the second sealing portion 220 has a liquid-tight structure so as to prevent leakage of liquid stored in the second chamber 120. According to the reaction vessel 1 in the first embodiment, the sealing mechanism is constituted by a combination of the vessel main body 300 and the cover 20. According to the example shown in FIGS. 1A and 1B, under the condition in which a part of the cover 20 is inserted through the opening 14 into the vessel chamber 10, the first sealing portion 210 seals at least a part of the first area 11 of the vessel chamber 10 to define the first chamber 110, while the second sealing portion 220 seals at least apart of the second area 12 of the vessel chamber 10 to define the second chamber 120.

According to the example shown in FIGS. 1A and 1B, a tip 22 of the cover 20 on the side inserted into the vessel chamber 10 has a tapered shape which has a circular cross section in the horizontal direction in FIGS. 1A and 1B and such an outside diameter decreasing toward the tip end, so that the tip 22 of the cover 20 can function as a tapered cap. The first sealing portion 210 seals at least a part of the first area 11 of the vessel chamber 10 by engagement between the tip 22 of the cover 20 and the inner wall surface (more specifically, the step X) of the first area 11 of the vessel chamber 10. The area sealed by the first sealing portion 210 (i.e., at least a part of the first area 11 of the vessel chamber 10) forms the first chamber 110. In other words, the area sectioned by the tip 22 of the cover 20 and the inner wall surface of the first area 11 of the vessel chamber 10 forms the first chamber 110.

According to the example shown in FIGS. 1A and 1B, a convex 24 is provided at an intermediate position of the cover 20. This convex 24 has a circular cross-sectional shape in the horizontal direction in FIGS. 1A and 1B, and has a locally larger outside diameter. Moreover, according to the example shown in FIGS. 1A and 1B, a concave 16 is provided at a position of the vessel chamber 10 in the vicinity of the opening 14. This concave 16 has a locally larger inside diameter. According to this structure, the second sealing portion 220 seals at least a part of the second area 12 of the vessel chamber 10 to define the second chamber 120 by engagement between the convex 24 of the cover 20 and the concave 16 of the vessel chamber 10. In other words, the area sectioned between the tip 22 of the cover 20 and the inner wall surface of the second area 12 of the vessel chamber 10 corresponds to the second chamber 120. In this arrangement, the positional relationship between the vessel main body 300 and the cover 20 can be fixed by engagement between the convex 24 of the cover 20 and the concave 16 of the vessel chamber 10.

The shapes of the first chamber 110 and the second chamber 120 are not specifically limited. The shape of the first chamber 110 may be so determined as to have a longitudinal direction, for example. According to the reaction vessel 1 in the first embodiment, the first chamber 110 has a long and narrow and substantially cylindrical shape whose longitudinal direction corresponds to the direction extending along the center axis of the vessel main body 300. The inside diameter of the first chamber 110 may be approximately in the range from 2 mm to 2.5 mm, and the length of the first chamber 110 in its longitudinal direction may be approximately in the range from 15 mm to 25 mm, for example.

It is preferable that the first chamber 110 is so constructed as to allow the second liquid 40 introduced into the first chamber 110 to shift along the opposed portions of the inner wall of the first chamber 110. The phrase “opposed portions of the inner wall” of the first chamber 110 herein refers to the two portions of the wall surface of the first chamber 110 positioned opposed to each other. The word “along” herein refers to the condition in which the distance between the second liquid 40 and the wall surface of the first chamber 110 is short, including the condition of contact between the second liquid 40 and the wall surface of the first chamber 110. Therefore, the phrase “the second liquid 40 shifts along the opposed portions of the inner wall” refers to the condition that “the second liquid 40 shifts at a short distance from both the two opposed portions of the wall surface of the first chamber 110”. In other words, the distance between the two opposed portions of the inner wall of the first chamber 110 is short enough to allow shift of the second liquid 40 along the inner wall. This shape of the first chamber 110 can regulate the flow direction of the second liquid 40 within the first chamber 110, and therefore can determine the shift route of the second liquid 40 within the first chamber 110 to some extent. In this case, the time required for the shift of the second liquid 40 within the first chamber 110 can be limited to a certain range. For example, when the temperature of the reaction vessel 1 is controlled by using a thermal cycling device 1000 described in the section of “3. Application Example of Reaction Vessel” such that areas having different temperatures can be defined within the first chamber 110, it is preferable that the distance between the two opposed portions of the inner wall of the first chamber 110 is short enough to reduce variations in the thermal cycling conditions given to the second liquid 40 to such a level as to achieve desired accuracy. In other words, it is preferable that the distance between the two opposed portions of the inner wall of the first chamber 110 is short enough to reduce variations in the result of the reaction produced by the variations in the time required for the shift of the second liquid 40 within the first chamber 110 to such a level as to achieve desired accuracy of the reaction result. More specifically, it is preferable that the distance between the two opposed portions of the inner wall of the first chamber 110 in the direction perpendicular to the shift direction of the second liquid 40 is short enough to prevent entrance of two or a larger number of liquid drops of the second liquid 40.

When the first chamber 110 has a long and narrow shape having a longitudinal direction, the ratio of the surface area of the first chamber 110 to the capacity of the first chamber 110 becomes large. Thus, when the first chamber 110 is filled with the first liquid 30, for example, the efficiency of heat conduction to the first liquid 30 improves, wherefore the temperature control over the first liquid 30 becomes easier. The second liquid 40 is a liquid not miscible with the first liquid 30. For example, the second liquid 40 may be a mixture of two types of liquids: a reagent containing enzymes and chemicals necessary for desired reaction and water as a medium; and an inspection liquid (liquid containing specimens). When the reaction vessel 1 is used for the PCR method, the second liquid 40 may contain at least either a set of enzymes and primers for amplifying target nucleic acids, or fluorescent probes for detecting amplified products. According to the first embodiment, the second liquid 40 contains all of the primers, enzymes, fluorescent probes, and specimens. Thus, the PCR method can be carried out for the second liquid 40 with the aid of thermal cycling device 1000 described later. The reagent and the inspection liquid may be brought into a mixed condition (i.e., the condition of the second liquid 40) before introduced into the reaction vessel 1. Alternatively, the inspection liquid may be introduced into the reaction vessel 1 into which the reagent and the first liquid 30 have been introduced beforehand so as to be mixed with the reagent therein.

The second liquid 40 may be a liquid having different specific gravity from that of the first liquid 30. According to the example shown in FIG. 2, the second liquid 40 is a liquid having higher specific gravity than that of the first liquid 30. In this case, the second liquid 40 can be positioned lower in the direction of gravity within the first chamber 110. When the second liquid 40 is a liquid having lower specific gravity than that of the first liquid 30, the second liquid 40 can be positioned higher in the direction of gravity within the first chamber 110.

According to the reaction vessel 1 in the first embodiment, on the assumption that the capacities of the first chamber 110 and the second chamber 120 are A and B, respectively, and that the volumes of the first liquid 30 and the second liquid 40 are C and D, respectively, the relationship A<C+D<A+B holds when the second liquid 40 is introduced through the opening 14 into the vessel chamber 10. The capacity A of the first chamber 110 is a capacity of the first chamber 110 when the cover 20 is attached to the vessel main body 300. The capacity B of the second chamber 120 is a capacity of the second chamber 120 when the cover 20 is attached to the vessel main body 300. According to the reaction vessel 1 in the first embodiment which satisfies the relationship A<C+D, the first chamber 110 sealed by the first sealing portion 210 can be brought into the condition filled with the first liquid 30 and the second liquid 40 as illustrated in FIG. 2. Under this condition, bubbles do not easily enter the first chamber 110 of the reaction vessel 1. For satisfying the relationship A<C+D, the condition A<C is allowed, for example. However, the condition A≧C is also allowed as long as the relationship A<C+D holds.

According to the reaction vessel 1 in the first embodiment which satisfies the relationship C+D<A+B, the first liquid 30 and the second liquid 40 do not overflow from the second chamber 120 sealed by the second sealing portion 220 as illustrated in FIG. 2. Therefore, the necessities of wiping off the second liquid 40 having overflowed from the second chamber 120, and providing an additional structure on the reaction vessel 1 for receiving the second liquid 40 are eliminated, for example. Accordingly, a reaction such as a thermal cycling can be applied through a simple operation using the reaction vessel 1 having a simplified structure.

It is preferable that the volume of the second liquid 40 is determined such that the second liquid 40 is contained as a liquid drop within the first liquid 30. The liquid drop is a form of liquid surrounded by its free surface. When existing as a liquid drop, the second liquid 40 does not adhere to the inner wall of the first chamber 110 by its surface tension. In this case, the second liquid 40 easily moves within the first chamber 110. Accordingly, a thermal cycling can be easily applied to the second liquid 40 using the thermal cycling device 1000 described later.

According to the reaction vessel 1 in the first embodiment, the volume of the second liquid 40 may be determined within the range from 1 pl to 10 μl. When the volume of the second liquid 40 is set within the range from 1 pl to 10 μl, the second liquid 40 easily becomes a liquid drop. According to the first embodiment, the volume of the second liquid 40 may be determined within the range from 1 μl to 3 μl. When the volume of the second liquid 40 is set within the range from 1 μl to 3 μl, the second liquid 40 can further easily become a liquid drop. When the inside diameter of the first chamber 110 lies approximately in the range from 2 mm to 2.5 mm, for example, it is further preferable that the volume of the second liquid 40 is determined within the range from 1 μl to 2.5 μl. In this case, the second liquid 40 becomes a liquid drop appropriately sized to shift along the opposed portions of the inner wall.

According to the reaction vessel 1 in the first embodiment, the inner wall of the first chamber 110 may have water repellency. In the case of the example shown in FIGS. 1A and 1B, the inner wall of the vessel chamber 10 of the vessel main body 300 and the cover 20 have water repellency. Examples of material having water repellency include polypropylene, for example. According to the first embodiment, the vessel main body 300 and the cover 20 are made of polypropylene. When the inner wall of the first chamber 110 has water repellency, the second liquid 40, particularly when including water as a medium, can be prevented from adhering to the wall surface of the first chamber 110. In this case, the second liquid 40 can easily shift within the first chamber 110. Accordingly, a thermal cycling can be easily applied to the second liquid 40 using the thermal cycling device 1000 described later.

According to the reaction vessel 1 in the first embodiment, with respect to the first chamber 110, the second chamber 120 may be disposed on the longitudinal direction side of the first chamber 110. In this case, when the opening 14 of the vessel chamber 10 is open to above with respect to the direction of gravity, bubbles having entered the first area 11 positioned relatively far from the opening 14 can easily shift toward the second area 12 positioned relatively close to the opening 14. Bubbles which do not easily enter the first area 11 are difficult to come into the first chamber 110. Accordingly, entrance of bubbles into the first chamber 110 of the reaction vessel 1 can be further prevented.

### 2. Reaction Vessel of Second Embodiment

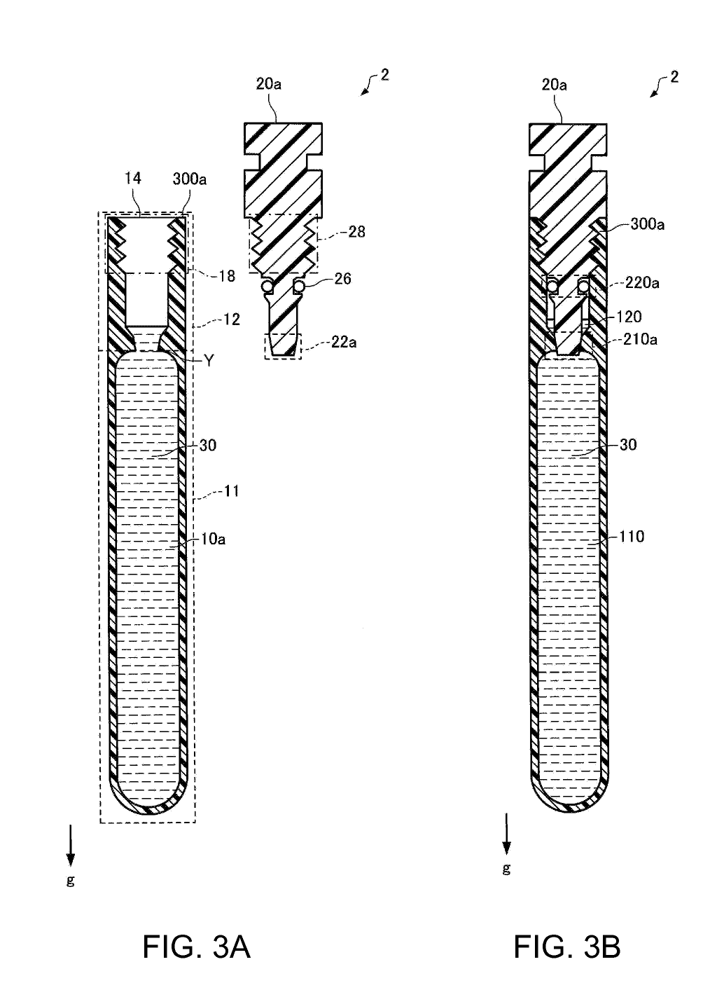

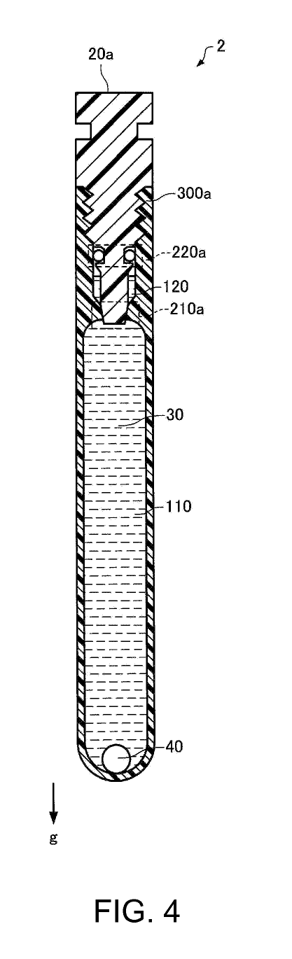

FIGS. 3A and 3B schematically illustrate a cross-sectional structure of a reaction vessel 2 according to a second embodiment. FIG. 3A shows a condition of the reaction vessel 2 whose cover 20a is removed from a vessel main body 300a, while FIG. 3B shows a condition of the reaction vessel 2 whose cover 20a is attached to the vessel main body 300a. FIG. 4 schematically illustrates a condition of the reaction vessel 2 into which the second liquid 40 is introduced. In each of FIGS. 3A, 3B and 4, the arrow g indicates the direction of gravity. In this section, structures different from the corresponding structures of the reaction vessel 1 in the first embodiment are chiefly discussed. The components and parts in this embodiment corresponding to the components and parts of the reaction vessel 1 in the first embodiment have been given similar reference numbers, and the same detailed explanation is not repeated.

The reaction vessel 2 in the second embodiment includes a vessel chamber 10a having the opening 14, the first area 11 disposed relatively far from the opening 14, and the second area 12 disposed relatively close to the opening 14, the cover 20a which seals at least a part of the first area 11 to define the first chamber 110 and also seals at least a part of the second area 12 to define the second chamber 120, and the first liquid 30 stored in the vessel chamber 10a. The reaction vessel 2 satisfies the relationship A<C+D<A+B on the assumption that the capacities of the first chamber 110 and the second chamber 120 are A and B, respectively, and that the volumes of the first liquid 30 and the second liquid 40 are C and D, respectively, when the second liquid 40 not miscible with the first liquid 30 is introduced through the opening 14 into the vessel chamber 10a.

According to the example shown in FIGS. 3A and 3B, the reaction vessel 2 includes the vessel main body 300a and the cover 20a. The materials of the vessel main body 300a and the cover 20a are similar to those of the vessel main body 300 and the cover 20 of the reaction vessel 1 in the first embodiment. The vessel main body 300a contains the vessel chamber 10a as a hollow formed inside the vessel main body 300a. The vessel chamber 10a stores the first liquid 30. The vessel chamber 10a has the opening 14, the first area 11, and the second area 12. The vessel chamber 10a communicates with the space outside the vessel main body 300a via the opening 14. According to the reaction vessel 2 in the second embodiment, the vessel chamber 10a is determined in such a form that its cross-sectional shape is circular in the horizontal direction in FIGS. 3A and 3B, and that the inside diameter of the circular shape differs for each position on the vessel chamber 10a in the vertical direction (height direction) in FIGS. 3A and 3B. The first area 11 is disposed within the vessel chamber 10a at a position relatively far from the opening 14. The second area 12 is disposed within the vessel chamber 10a at a position relatively close to the opening 14. Thus, the opening 14 is positioned farther from the first area 11 than from the second area 12, and positioned closer to the second area 12 than to the first area 11. According to the example shown in FIGS. 3A and 3B, the region located relatively far from the opening 14 corresponds to the first area 11, and the region located relatively close to the opening 14 corresponds to the second area 12, with the boundary between these areas 11 and 12 positioned at a narrow portion Y where the inside diameter locally decreases.

The cover 20a is so constructed as to be attachable to the vessel main body 300a. The cover 20a is attached in such a manner as to cover the opening 14 communicating with the vessel chamber 10a of the vessel main body 300a. According to the example shown in FIGS. 3A and 3B, the cover 20a is provided as a cap fitted into the vessel chamber 10a of the vessel main body 300a. The cover 20a is also so constructed as to be detachable from the vessel main body 300a.

The cover 20a is so designed as to seal at least a part of the first area 11 of the vessel chamber 10a (that is, a part or the whole of the first area 11) to define the first chamber 110. Similarly, the cover 20a seals at least a part of the second area 12 of the vessel chamber 10a (that is, a part or the whole of the second area 12) to define the second chamber 120. Therefore, the cover 20a is provided as a part of a sealing mechanism capable of switching the condition of the vessel chamber 10a between a sealing condition in which at least a part of the first area 11 of the vessel chamber 10a and at least a part of the second area 12 of the vessel chamber 10a are sealed to define the first chamber 110 and the second chamber 120, and a non-sealing condition in which the vessel chamber 10a is not sealed.

According to the reaction vessel 2 in the second embodiment, the sealing mechanism is constituted by a combination of the vessel main body 300a and the cover 20a. According to the example shown in FIGS. 3A and 3B, under the condition in which apart of the cover 20a is inserted through the opening 14 into the vessel chamber 10a, a first sealing portion 210a seals at least a part of the first area 11 of the vessel chamber 10a to define the first chamber 110, while a second sealing portion 220a seals at least a part of the second area 12 of the vessel chamber 10a to define the second chamber 120.

According to the example shown in FIGS. 3A and 3B, a tip 22a of the cover 20a has a tapered shape which has a circular cross section in the horizontal direction in FIGS. 3A and 3B and such an outside diameter decreasing toward the tip end, so that the tip 22a of the cover 20a can function as a tapered cap. The first sealing portion 210a seals at least a part of the first area 11 of the vessel chamber 10a by engagement between the tip 22a of the cover 20a and the inner wall surface of the narrow portion Y of the vessel chamber 10a to define the first chamber 110. In other words, the area sectioned by the tip 22a of the cover 20a and the inner wall surface of the first area 11 of the vessel chamber 10a forms the first chamber 110.

According to the example shown in FIGS. 3A and 3B, a portion which has a circular cross-sectional shape in the horizontal direction in FIGS. 3A and 3B is formed at an intermediate position of the cover 20a, and an O-ring 26 is provided on a part of the outer circumference of this circular portion. According to this structure, the second sealing portion 220a seals at least apart of the second area 12 of the vessel chamber 10a by close contact between the O-ring 26 of the cover 20a and the inner wall surface of the second area 12 of the vessel chamber 10a to define the second chamber 120. In other words, the area sectioned by the intermediate portion of the cover 20a, the O-ring 26, and the inner wall surface of the second area 12 of the vessel chamber 10a corresponds to the second chamber 120.

According to the example shown in FIGS. 3A and 3B, a male screw 28 is formed in an area of the cover 20a, from where the tip of the cover 20a is positioned farther than from the O-ring 26. A female screw 18 is further formed in the vessel chamber 10a in the vicinity of the opening 14. According to this structure, the positional relationship between the vessel main body 300a and the cover 20a is fixed by screw-engagement between the male screw 28 of the cover 20a and the female screw 18 of the vessel chamber 10a.

The shapes of the first chamber 110 and the second chamber 120 are not specifically limited. For example, the first chamber 110 may be so shaped as to have a longitudinal direction. According to the reaction vessel 2 in the second embodiment, the first chamber 110 has a long and narrow cylindrical shape whose longitudinal direction corresponds to the direction extending along the center axis of the vessel main body 300a. This shape can regulate the shift route of the second liquid 40 within the first chamber 110 to some extent. Accordingly, a thermal cycling can be easily applied to the second liquid 40 with the aid of a thermal cycling device (such as the thermal cycling device 1000 described later) which shifts the second liquid 40 by gravity within the reaction vessel 2. According to the reaction vessel 2 in the second embodiment, on the assumption that the capacities of the first chamber 110 and the second chamber 120 are A and B, respectively, and that the volumes of the first liquid 30 and the second liquid 40 are C and D, respectively, the relationship A<C+D<A+B holds when the second liquid 40 is introduced through the opening 14 into the vessel chamber 10a. The capacity A of the first chamber 110 is a capacity of the first chamber 110 when the cover 20a is attached to the vessel main body 300a. The capacity B of the second chamber 120 is a capacity of the second chamber 120 when the cover 20a is attached to the vessel main body 300a.

According to the reaction vessel 2 in the second embodiment which satisfies the relationship A<C+D, the first chamber 110 sealed by the first sealing portion 210a can be brought into the condition filled with the first liquid 30 and the second liquid 40 as illustrated in FIG. 4. Under this condition, bubbles do not easily enter the first chamber 110 of the reaction vessel 2.

According to the reaction vessel 2 in the second embodiment which satisfies the relationship C+D<A+B, the first liquid 30 and the second liquid 40 do not overflow from the second chamber 120 sealed by the second sealing portion 220a as illustrated in FIG. 4.

According to the reaction vessel 2 in the second embodiment, the inner wall of the first chamber 110 may have water repellency. In the case of the example shown in FIGS. 3A and 3B, the inner wall of the vessel chamber 10a of the vessel main body 300a and the cover 20a have water repellency. According to the second embodiment, the vessel main body 300a and the cover 20a are made of polypropylene.

When the inner wall of the first chamber 110 has water repellency, the second liquid 40, particularly when including water as a medium, can be prevented from adhering to the wall surface of the first chamber 110. In this case, the second liquid 40 can easily shift within the first chamber 110. Accordingly, a thermal cycling can be easily applied to the second liquid 40 using the thermal cycling device 1000 described later.

According to the reaction vessel 2 in the second embodiment, with respect to the first chamber 110, the second chamber 120 may be disposed on the longitudinal direction side of the first chamber 110. In this case, when the opening 14 of the vessel chamber 10a is open to above with respect to the direction of gravity, bubbles having entered the first area 11 positioned relatively far from the opening 14 can easily shift toward the second area 12 positioned relatively close to the opening 14. Bubbles which do not easily enter the first area 11 are difficult to come into the first chamber 110. Accordingly, entrance of bubbles into the first chamber 110 of the reaction vessel 2 can be further prevented.

### 3. Application Example of Reaction Vessel

An application example of the reaction vessel according to the embodiments is now described. Discussed in this section as an example is a thermal cycling applied to the second liquid 40 introduced into the first chambers 110 of the reaction vessels 1 according to the first embodiment illustrated in FIG. 2 by the use of a thermal cycling device. It is assumed that the specific gravity of the first liquid 30 is lower than that of the second liquid 40 in the example. The reaction vessel 2 in the second embodiment can be employed in a similar manner in place of the reaction vessel 1 in the first embodiment. Initially, an example of the thermal cycling device is explained. Thermal cycling device 1000 in this example applies a thermal cycling by reciprocating reaction liquid (second liquid 40 in this example) contained as a liquid drop in each of the reaction vessels filled with a liquid (first liquid 30 in this example) not miscible with the reaction liquid and having specific gravity different from that of the reaction liquid between an area having a certain temperature within each of the reaction vessels and another area having a different temperature within each of the reaction vessels.

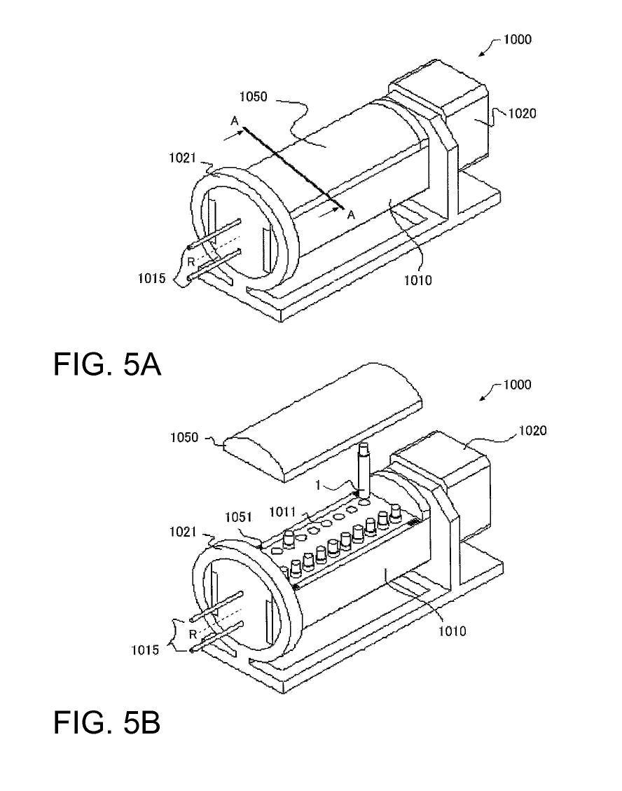

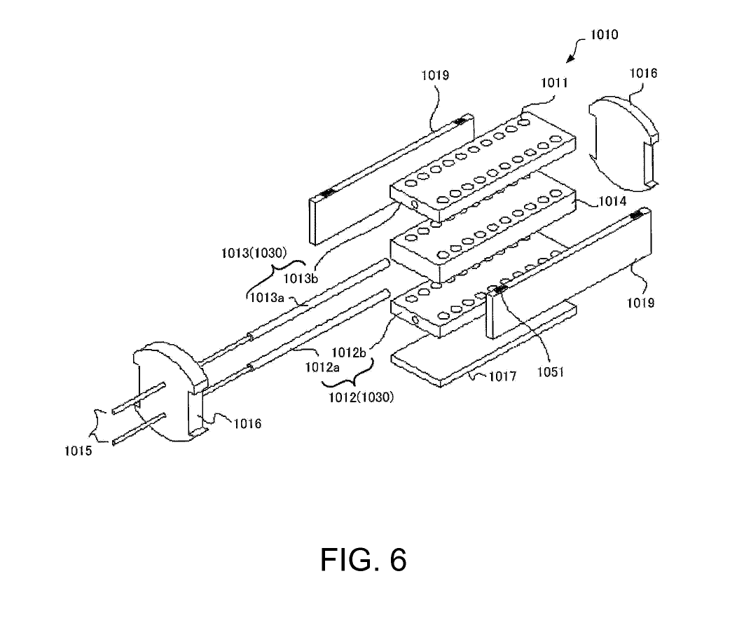

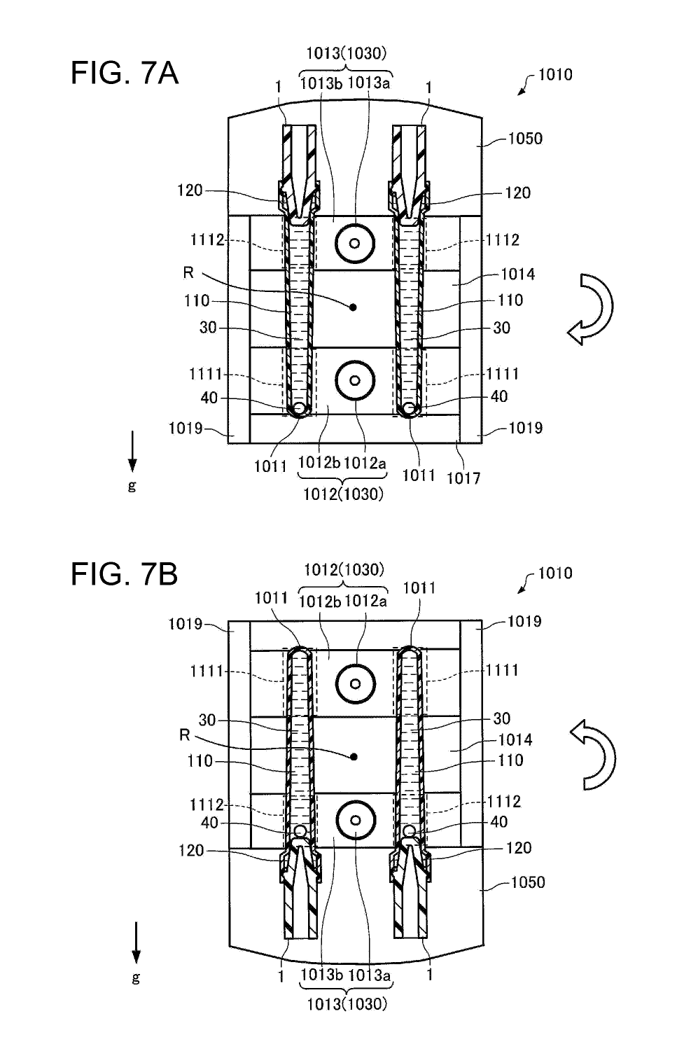

FIG. 5A is a perspective view illustrating a condition of the thermal cycling device 1000 whose cover 1050 is closed, while FIG. 5B is a perspective view illustrating a condition of the thermal cycling device 1000 whose cover 1050 is opened. FIG. 6 is a perspective view of a main body 1010 of the thermal cycling device 1000 in a disassembled condition. FIG. 7A is a cross-sectional view schematically illustrating a cross section taken along a plane passing through a line A-A in FIG. 5A and perpendicular to the rotation axis R in a first position, while FIG. 7B is a cross-sectional view schematically illustrating a cross section taken along the plane passing through the line A-A in FIG. 5A and perpendicular to the rotation axis R in a second position. In each of FIGS. 7A and 7B, a white arrow indicates the rotation direction of the main body 1010, and an arrow g indicates the direction of gravity. The thermal cycling device 1000 shown in FIGS. 5A, 5B, and 6 includes attachment portions 1011 to which the reaction vessels 1 are attached, a temperature gradient producing unit 1030 which produces a temperature gradient for each of the first chambers 110 of the reaction vessels 1 in the shift direction of the second liquid 40 (longitudinal direction of the first chambers 110 in this example) when the reaction vessels 1 are attached to the attachment portions 1011, and a driving mechanism 1020 which rotates the attachment portions 1011 and the temperature gradient producing unit 1030 around the same rotation axis R extending in the direction corresponding to horizontal components.

According to the example shown in FIGS. 5A and 5B, the thermal cycling device 1000 contains the main body 1010 and the driving mechanism 1020. As illustrated in FIG. 6, the main body 1010 has the attachment portions 1011 and the temperature gradient producing unit 1030.

The attachment portions 1011 are structured to which the reaction vessels 1 are attached. According to the example shown in FIGS. 5B and 6, each of the attachment portions 1011 of the thermal cycling device 1000 has a slot structure into which the reaction vessel 1 is inserted for attachment thereto. According to the example shown in FIG. 6, each of the attachment portions 1011 has a hole penetrating a first heat block 1012b of a first heating unit 1012, a spacer 1014, and a second heat block 1013b of a second heating unit 1013 (all described later) as a hole into which the reaction vessel 1 is inserted. According to the example shown in FIG. 5B, the twenty attachment portions 1011 are provided in the main body 1010.

The temperature gradient producing unit 1030 produces a temperature gradient for the first chambers 110 of the reaction vessels 1 in the shift direction of the second liquid 40 when the reaction vessels 1 are attached to the attachment portions 1011. The phrase “produces a temperature gradient” refers to the function of producing such a condition in which the temperature changes in a predetermined direction. Therefore, the phrase “produces a temperature gradient in the shift direction of the second liquid 40” refers to the function of producing such a condition in which the temperature changes in the shift direction of the second liquid 40. The condition of “temperature change in a predetermined direction” herein may be either the condition in which the temperature monotonously increases or decreases in a predetermined direction, or the condition in which the temperature change switches from increase to decrease or from decrease to increase during the temperature change, for example. According to the example shown in FIG. 6, the temperature gradient producing unit 1030 includes the first heating unit 1012 and the second heating unit 1013. There may be further provided the spacer 1014 between the first heating unit 1012 and the second heating unit 1013. According to the structure of the main body 1010 of the thermal cycling device 1000, the peripheries of the first heating unit 1012, the second heating unit 1013, and the spacer 1014 are fixed by flanges 1016, a bottom plate 1017, and fixing plates 1019.

The first heating unit 1012 raises the temperatures of first temperature areas 1111 of the first chambers 110 to a first temperature when the reaction vessels 1 are attached to the attachment portions 1011. According to the example shown in FIGS. 7A and 7B, the first heating unit 1012 is disposed on the main body 1010 in such a position as to heat the first temperature areas 1111 of the first chambers 110.

According to the example shown in FIG. 6, the first heating unit 1012 includes a first heater 1012a as a mechanism for generating heat, and the first heat block 1012b as a component for transmitting the generated heat to the reaction vessels 1. According to the structure of the thermal cycling device 1000, the first heater 1012a is a cartridge heater connected with a not-shown external power source via leads 1015.

The second heating unit 1013 raises the temperatures of second temperature areas 1112 of the first chambers 110 to a second temperature different from the first temperature when the reaction vessels 1 are attached to the attachment portions 1011. According to the example shown in FIGS. 7A and 7B, the second heating unit 1013 is disposed on the main body 1010 in such a position as to heat the second temperature areas 1112 of the reaction vessels 1. The second heating unit 1013 includes a second heater 1013a and the second heat block 1013b. The second heating unit 1013 has a structure similar to that of the first heating unit 1012 except that the heating areas of the first chambers 110 and the heating temperature are different from those of the first heating unit 1012.

The temperatures of the first heating unit 1012 and the second heating unit 1013 may be controlled by a not-shown temperature sensor and a controller (described later).

The driving mechanism 1020 is a mechanism for rotating the attachment portions 1011 and the temperature gradient producing unit 1030 around the same rotation axis R which extends in the direction corresponding to horizontal components. The “direction corresponding to horizontal components” refers to the direction of horizontal components when directions are expressed by the vector sum of vertical components (components parallel with the direction of gravity) and horizontal components (components perpendicular to the direction of gravity). According to this example, the driving mechanism 1020 includes a not-shown motor and a not-shown driving shaft, the shaft is connected with the flanges 1016 of the main body 1010. Upon actuation of the motor of the driving mechanism 1020, the main body 1010 starts rotation around the driving shaft corresponding to the rotation axis R.

The thermal cycling device 1000 may include the not-shown controller. The controller controls at least either the driving mechanism 1020 or the temperature gradient producing unit 1030. The controller may have a dedicated circuit to perform respective controls (described later). The controller may be structured such that a CPU (central processing unit) executes control programs stored in a memory unit such as a ROM (read only memory) and a RAM (random access memory), for example, so as to function as a computer and perform respective controls (described later).

The thermal cycling device 1000 may include the cover 1050. According to the example shown in FIGS. 5A, 7A and 7B, the cover 1050 covers the attachment portions 1011.

As illustrated in FIG. 7A, the first position is a position in which the end of the first chamber 110 of each of the reaction vessels 1 on the side relatively far from the cover 20 is located at the lowermost position in the direction of gravity. In other words, the first position is a position in which the first temperature area 1111 of each of the first chambers 110 is located at the lowermost position of the first chamber 110 in the direction of gravity when the reaction vessels 1 are attached to the attachment portions 1011. According to the example shown in FIG. 7A, the second liquid 40 having higher specific gravity than that of the first liquid 30 exists in the first temperature areas 1111 in the first position. Thus, the second liquid 40 lies under the condition of the first temperature.

As illustrated in FIG. 7B, the second position is a position in which the end of the first chamber 110 of each of the reaction vessels 1 on the side relatively close to the cover 20 is located at the lowermost position in the direction of gravity. In other words, the second position is a position in which the second temperature area 1112 of each of the first chambers 110 is located at the lowermost position of the first chamber 110 in the direction of gravity when the reaction vessels 1 are attached to the attachment portions 1011. According to the example shown in FIG. 7B, the second liquid 40 having higher specific gravity than that of the first liquid 30 exists in the second temperature areas 1112 in the second position. Thus, the second liquid 40 lies under the condition of the second temperature.

According to this structure, therefore, the driving mechanism 1020 rotates the attachment portions 1011 and the temperature gradient producing unit 1030 between the first position and the second position different from the first position to apply a thermal cycling to the second liquid 40.

It should be understood that the embodiments and modified examples described herein are shown only as examples of the invention, and therefore do not limit the scope of the invention. For example, a combination of plural examples of any of the embodiments and modified examples is included in the scope of the invention.

The invention is not limited to the embodiments described herein but may be practiced otherwise in various ways. For example, a structure substantially equivalent to the structure explained in the embodiments (such as a structure producing an equivalent function, method, or result, and a structure achieving an equivalent object or advantage); a structure which contains parts not essential and different from the corresponding parts in the embodiments in place of these parts; a structure which can offer an advantage equivalent to the corresponding advantage in the embodiments or achieve an object equivalent to the corresponding object in the embodiments; and a structure as a combination of the structure described in the embodiments and a known technology added thereto are all included in the scope of the invention.

What is claimed is:

1. A reaction vessel comprising:
a vessel chamber including an opening, a first area, and a second area which is closer to the opening than the first area;
a cover capable of sealing at least a part of the first area to define a first chamber and sealing at least a part of the second area to define a second chamber; and
a first liquid stored in the vessel chamber,
wherein
when a second liquid not miscible with the first liquid is introduced through the opening into the vessel chamber, on the assumption that the capacities of the first chamber and the second chamber are A and B, respectively, and the volumes of the first liquid and the second liquid are C and D, respectively, a relationship A<C+D<A+B holds.

2. The reaction vessel according to claim 1, wherein the shape of the first chamber has a longitudinal direction.

3. The reaction vessel according to claim 2, wherein the second chamber is disposed with respect to the first chamber, on the longitudinal direction side of the first chamber.
